(19) United States
(12) Patent Application Publication
(10) Pub. No.: US 2015/0010412 A1
(43) Pub. Date: Jan. 8, 2015

(54) STATOR, MOTOR AND COMPRESSOR

(71) Applicant: Danfoss Tianjin Ltd., Tianjin (CN)

(72) Inventors: Wanzhen Liu, Tianjin (CN); Li Yao, Tianjin (CN); Yan Lin, Tianjin (CN); Guangqiang Liu, Tianjin (CN); Zhenyu Wang, Tianjin (CN); Weiping Tang, Tianjin (CN)

(21) Appl. No.: 14/320,883

(22) Filed: Jul. 1, 2014

(30) Foreign Application Priority Data
Jul. 2, 2013 (CN) 201310275900.2

(51) Int. Cl. H02K 3/28; H02K 3/12

(52) U.S. Cl. CPC H02K 3/28; H02K 3/12
USPC 417/410.1; 310/198

(57) ABSTRACT

A stator, a motor and a compressor are provided. A stator applied to a motor includes: a stator iron core; a plurality of stator teeth extending inwards along a radial direction of the stator; stator slots distributed between the plurality of stator teeth; and a winding wound around the stator teeth to generate a rotating magnetic field, where at least one phase of winding or a coil forming the at least one phase of winding is formed by different wires, and the different wires are connected in a serial or serial-parallel manner to form the coil or the least one phase winding.

### CROSS REFERENCE TO RELATED APPLICATIONS

Applicant hereby claims foreign priority benefits under U.S.C. §119 from Chinese Patent Application Serial No. CN201310275900.2 filed on Jul. 2, 2013, the contents of which are incorporated by reference herein.

### FIELD OF THE INVENTION

The present invention relates to the technical field of air-conditioning or refrigeration, and more particularly, to a motor, a stator of a motor, and a compressor.

### BACKGROUND OF INVENTION

A motor usually includes a stator installed inside a shell and a rotor installed inside the stator and supported on the shell to rotate relative to the stator. The stator and/or rotor of the motor have a winding including a coil. In the motor, electrical power passes through the coil to generate a magnetic field to enable the rotor to rotate. Conventionally, a winding is usually made of copper or a copper alloy.

A motor, especially an induction motor, may be usually used for driving a compressor (for example, a scroll compressor) used in the field of air conditioning or refrigeration. However, the size, performance, and cost of compressor apparatus with a motor usually affect the size and cost of an air conditioning apparatus having the compressor apparatus significantly.

Currently, there are mainly improvements in the following two aspects for the foregoing problems.

As for efficiency, a permanent-magnet motor is usually used in place of an induction motor to enhance efficiency, or an optimization algorithm is used to optimize the design of a motor. However, by this way, the efficiency of a motor can only be improved to a limit, and it becomes very difficult to continue to improve the efficiency of a motor any more.

As cost, an aluminum wire motor is usually used in place of a copper wire motor. However, the use of an aluminum wire motor results in an excessive increase of the size of the motor, which is especially unsuitable for an application which has a limitation to the size of a motor.

### SUMMARY OF THE INVENTION

Embodiments of the present invention are to solve at least one aspect of the foregoing problems and defects in the prior art.

An aspect of the present invention provides a stator applied to a single-phase or multi-phase motor, which includes: a stator iron core; a plurality of stator teeth extending inwards along a radial direction of the stator; stator slots distributed between the plurality of stator teeth; and a single-phase winding or multi-phase windings wound around the stator teeth to generate a rotating magnetic field, where at least one phase of winding or a coil forming the at least one phase of winding is formed by different wires, and the different wires are connected in a serial or serial-parallel manner to form the coil or the at least one phase of winding.

In an example, inside one same stator slot, at least two types of wires are connected in a serial manner to form the coil or the winding.

Specifically, the at least two types of wires are a copper wire and an aluminum wire, and the copper wire and the aluminum wire are connected in series to form the coil or the winding.

In another example, inside different stator slots, at least two types of wires are connected in a serial manner to form the coil or the winding.

In yet another example, inside one same stator slot, wires are connected in a serial-parallel manner to form the coil or the winding.

In further an example, inside different stator slots, wires are connected in a serial-parallel manner to form the coil or the winding.

Preferably, different wires are wires made of a same material and having different cross-sectional areas, or wires made of different materials and having different electrical conductivity.

Specifically, a core portion of the wire is made of a metal material, and the core portion of the wire is circumferentially configured with an insulating layer or an insulating paint.

Furthermore, the metal is any one of copper, aluminum, silver, gold, and an alloy.

Another aspect of the present invention provides a motor, which includes a rotor and a stator, the rotor being rotatably arranged in the stator and is separated from the stator by a distance, where the stator is the foregoing stator.

Specifically, the motor may be a constant-frequency motor or a variable-frequency motor.

Preferably, the motor is a three-phase induction motor or a three-phase permanent-magnet motor.

Specifically, a working voltage of the motor or a driver of the motor is 208 V to 575 V.

Yet another aspect of the present invention provides a compressor, the compressor including a compression mechanism and the foregoing stator or motor is used in the compressor.

As can be seen, the motor in accordance with embodiments of the present invention has improved motor efficiency and a lower cost.

### BRIEF DESCRIPTION OF THE DRAWINGS

These and/or other aspects and advantages of the present invention will become clear and readily comprehensible through the description of preferred embodiments below with reference to the accompanying drawings, where:

FIG. 1 is a schematic view of a compressor using a three-phase induction motor according to an embodiment of the present invention;

FIG. 2 is a schematic cross-sectional view of a stator of a three-phase induction motor used in a compressor according to an embodiment of the present invention, where only a phase-A winding is shown;

FIG. 3 shows a specific example of a coil forming the phase-A winding shown in FIG. 2;

FIG. 4a and FIG. 4b show other two specific examples of a serial connection of coils forming the phase-A winding shown in FIG. 2;

FIG. 5a and FIG. 5b show two specific examples of a connection in a serial-parallel manner of coils forming the phase-A winding shown in FIG. 2;

FIG. 6 is a schematic cross-sectional view of another example of a stator of a three-phase induction motor used in a compressor according to an embodiment of the present invention, where only one coil of a phase-A winding is shown;

FIG. 7a and FIG. 7b show two examples of another form of forming the coil in FIG. 6; and

FIG. 8a and FIG. 8b show two examples of another form of forming the coil in accordance with an embodiment of the present invention.

### DETAILED DESCRIPTION

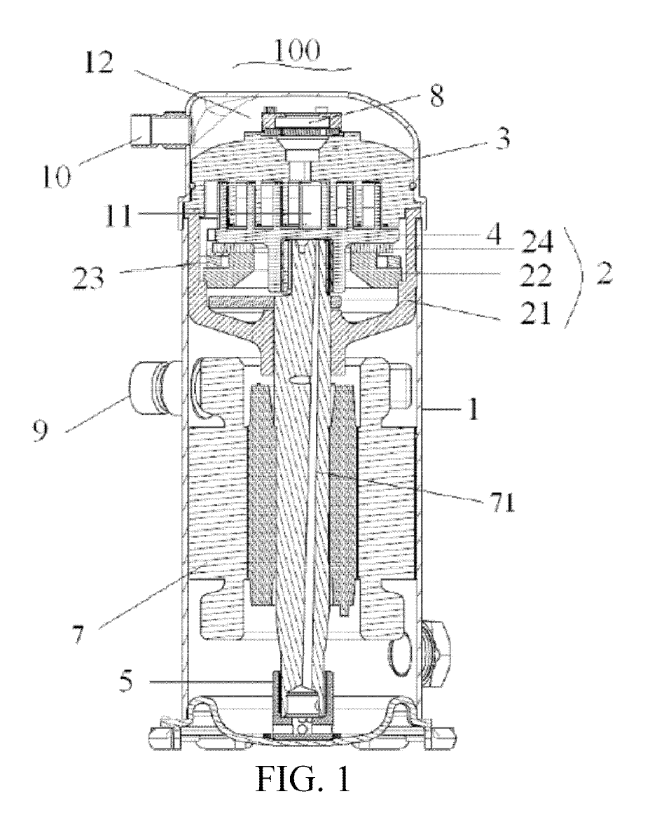

The technical solutions of the present invention are further specifically illustrated below through the embodiments with reference to the accompanying drawings FIG. 1 to FIG. 8b. In the description, same or similar reference signs in the accompanying drawings indicate same or similar members. The following illustration of implementation manners of the present invention with reference to the accompanying drawings intends to explain the general inventive concept of the present invention, and should not be construed as a limitation to the present invention.

Generally, a compressor may be used in the field of air conditioning or refrigeration. The compressor can convert mechanical energy into energy which is able to compress fluid or gas. The compressor may include a reciprocating compressor, a scroll-type compressor (i.e., scroll compressor), a centrifugal compressor, and a vane compressor.

Only a scroll compressor is used as an example below to illustrate arrangement and structure of a motor in the scroll compressor. It should be noted that the motor in accordance with embodiments of the present invention should not be limited to be used in the scroll compressor.

Typically, the working principle of a scroll compressor is that an orbiting scroll rotates around a base circle center of a fixed scroll, and the volume of a gas compression chamber formed by the orbiting scroll and the fixed scroll is gradually reduced to achieve an objective of gas compression. The orbiting scroll is directly supported on a supporting housing fixed to a shell of the compressor. In addition, an end (upper end) of a crankshaft used for driving the orbiting scroll to rotate is connected to the orbiting scroll through a central hole in the supporting housing, and the other end (lower end) of the crankshaft is directly supported on a lower support frame fixed inside the shell of the scroll compressor, so that when the crankshaft rotates in a clockwise or counterclockwise direction, corresponding gas suction, gas compression and gas discharge operations can be executed. The compressed gas may be discharged into a high-pressure cavity of the scroll compressor through a discharge valve, and may be eventually discharged through a discharge port.

As shown in FIG. 1, FIG. 1 shows a scroll compressor 100 according to an embodiment of the present invention. The scroll compressor 100 includes: a scroll compressor shell 1; a housing 2, the housing 2 being fixed inside the scroll compressor shell 1; a fixed scroll 3, fixed in the scroll compressor shell 1; an orbiting scroll 4, rotatably supported on the housing 2 and cooperating with the fixed scroll 3 to form a gas compression chamber 11; a lower support frame 5, fixed at a lower end of the compressor shell 1; a driving mechanism 7 such as a motor, fixed at a lower end of the scroll compressor 100 and transferring a rotational force through a crankshaft mechanism 71. An upper end of the crankshaft mechanism 71 is connected to the orbiting scroll 4 to drive the orbiting scroll 4 to rotate, and a lower end of the crankshaft mechanism 71 is supported on the lower support frame 5; and a discharge valve 8, used for discharging gas in the gas compression chamber 11 and preventing gas from flowing back into the scroll compressor 100.

The orbiting scroll 4 is supported on an upper surface or a support surface of the housing 2; the scroll compressor shell 1 defines a hermetic space inside, and accommodates the foregoing components such as the fixed scroll 3, the orbiting scroll 4 and the housing 2. A scroll wrap structure of the fixed scroll 3 and a scroll wrap structure of the orbiting scroll 4 are engaged or joined with each other to cooperate with each other to form the compression chamber 11. The fixed scroll 3 is disposed above the orbiting scroll 4. The motor 7 includes a stator and a rotor, and the motor drives the orbiting scroll 4 by the crankshaft mechanism 71.

During operation of the scroll compressor 100, the scroll compressor 100 sucks in gas through a suction port 9. After the driving mechanism 7 (e.g., the motor) is started, the orbiting scroll 4 is driven by the crankshaft mechanism 71 and is constrained by an anti-rotation oldham coupling, and makes a rotary reverse movement with a small radius around a base circle center of the fixed scroll 3, so as to generate a high-pressure and high-temperature gas in the gas compression chamber 11 formed by the orbiting scroll 4 and the fixed scroll 3. The high-pressure and high-temperature gas may be discharged into the high-pressure cavity 12 through the discharge valve 8 with the movement of the orbiting scroll 4. The discharge valve 8 may be used to prevent the gas in the high-pressure cavity 12 from flowing back. Eventually, the gas in the high-pressure cavity 12 is discharged through a gas discharge port 10. The foregoing process is repeated, so as to generate a high-temperature and high-pressure gas in the scroll compressor 100 continuously.

In an embodiment of the present invention, the housing 2 may include a support body 21 and a support disk 22. In addition, the support body 21 may be fixed in the scroll compressor shell 1 in, e.g., an interference fit manner, and may be lapped over a shell end surface of the scroll compressor 100. The support disk 22 may be fixed on the support body 21 in, e.g., a gap fit manner, and may include a sliding slot which may be lapped over the support body 21, thereby fixing the support disk 22 and preventing the support disk 22 from rotating. An oldham coupling 23 may have an upper protrusion and a lower protrusion opposite each other and distributed in a cross shape, where the lower protrusion is inserted inside the sliding slot on the support disk 22, and the upper protrusion is inserted inside an ear slot of the orbiting scroll 4. As the scroll compressor 100 starts working, the orbiting scroll 4 can orbit with a small radius relative to the support disk 22.

If necessary (for example, when a support area, for supporting the orbiting scroll 4, of the support disk 22 is not large enough), a thrust bearing disk 24 may be further disposed between the orbiting scroll 4 and the oldham coupling 23 to increase the support area for the orbiting scroll 4, and the thrust bearing disk 24 may be fixed in an interference fit manner and may be lapped over the support disk 22 and support the orbiting scroll 4.

A compression principle and compression operations of the scroll compressor 100 will not be described in detail here.

As shown in FIG. 1, the motor used for the compressor is usually a three-phase induction motor. However, it should be understood that the motor is not limited to the three-phase induction motor in accordance with an embodiment of the present invention. The three-phase induction motor shown here is only an example, and the inventive concept of the present invention can be used for any other types of motors, as long as it is feasible.

A motor (for example, a one-phase or multi-phase motor) may include a stator, a rotor, and some other relevant members (such as a shell). A stator of a motor is improved in embodiments of the present invention, and the improved stator may be used in a motor when the motor is manufactured or designed.

Generally, the motor mainly includes a rotor and a stator. The rotor is rotatably disposed in the stator and is separated from the stator by a distance. The motor may be a constant-frequency or a variable-frequency motor. The working voltage of the motor or a driver of the motor may be 208 V to 575 V. It should be noted that, the motor in accordance embodiments of the present invention is not limited to a specific type of motor, and for example, may be a single-phase motor or a multi-phase motor such as a three-phase motor.

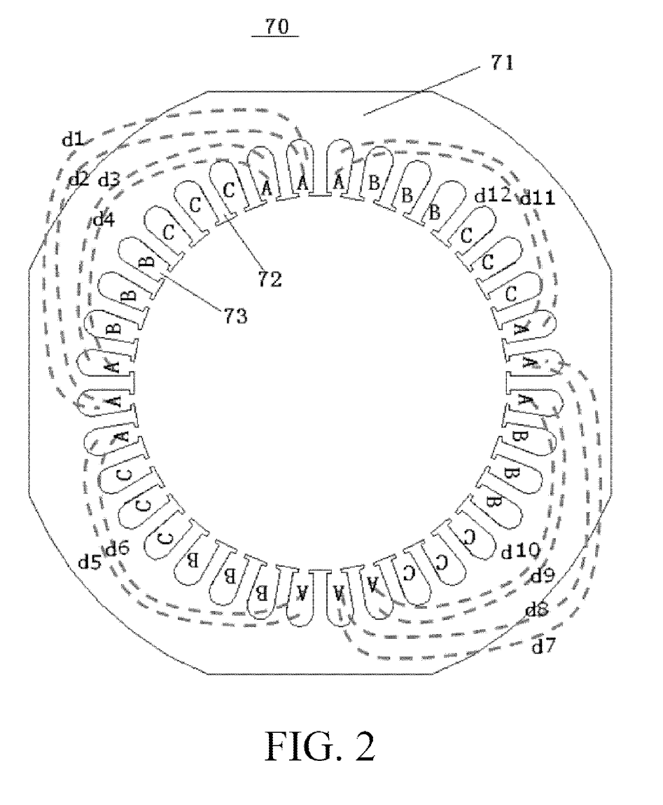

FIG. 2 is a schematic cross-sectional view of a stator of a three-phase induction motor, which is only an example of the present invention and the present invention should not be only limited to of the three-phase induction motor shown in FIG. 2. The stator 70 includes: a stator iron core 71, having an approximately cylindrical shape or other feasible shapes; a plurality of stator teeth 72 extending inwards along a radial direction of the stator; stator slots 73 distributed between the plurality of stator teeth 72; and three phases of windings wound around the stator teeth 72 to generate a rotating magnetic field and sequentially separated in space by a certain electric angle, for example, 120°. In FIG. 2, the three phases of windings are also shown as phase-A, phase-B, and phase-C windings.

In the embodiment of the present invention, a coil of any phase of winding (e.g., the phase-A winding, the phase-B winding or the phase-C winding) may be formed by different wires (that is, at least two different wires (that is, enamel-covered wires)), and the different wires are connected in a serial or serial-parallel manner. It should be noted here that the different wires in an embodiment of the present invention may be wires made of a same material and having different cross-sectional areas, or wires made of different materials and having different electrical conductivity (that is, in wires formed of different materials, cross-sectional areas of the wires may be the same or different). Specifically, a core portion of a wire is made of a metal material, and the core portion of the wire is circumferentially disposed with an insulating layer or an insulating paint. Furthermore, the metal material may be any one of copper, aluminum, silver, gold, and an alloy thereof.

According to an example, each phase of winding, for example, the phase-A winding in FIG. 2 may be formed by at least two different wires connected in a serial or serial-parallel manner. It should be noted that the two different wires herein mainly refer to conductors in the wires formed of different materials, or conductors in the wires formed of a same material but having different cross-sections. For example, two different copper wires may refer to copper wires with different cross-sectional areas or different inner diameters. FIG. 2A shows a specific manner of forming a phase-A winding, that is, by using 12 groups of wires d1 to d12.

In FIG. 2, the shape of the stator iron core 71 may have an approximately cylindrical shape or cylindrical shape shown in FIG. 2, that is, the cylindrical shape with four cutting edges along the stator iron core 71 in FIG. 2. Any known shape in the art may be used for the stator iron core 71, and the present invention will not make limitation.

Two different conductors will be used as examples hereinafter to illustrate a winding or a coil of a winding in accordance with an embodiment of the present invention, and a copper wire and an aluminum wire are used as examples for illustration. Alternatively, other wires, such as a wire made of any one of copper, aluminum, silver, gold and an alloy thereof, may be used in the embodiments of the present invention.

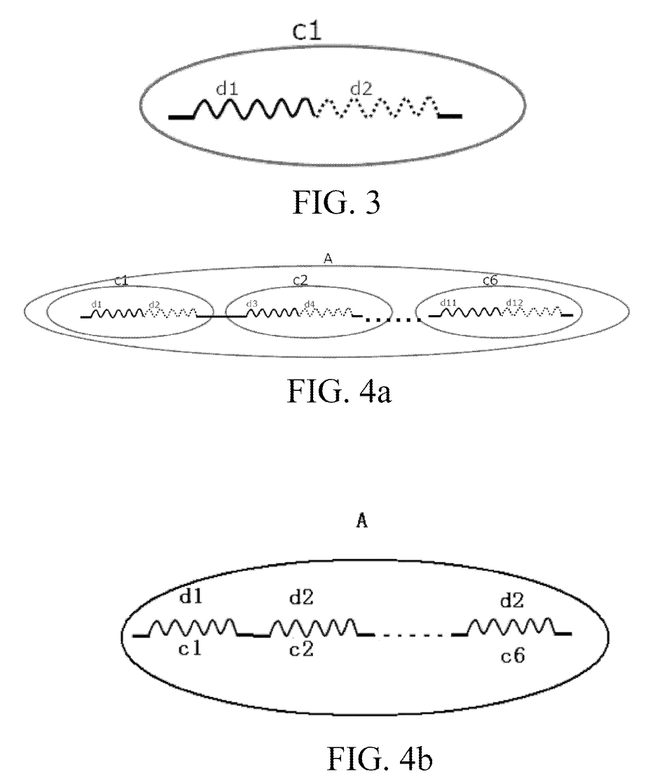

FIG. 3 shows a specific example of a coil forming the phase-A winding shown in FIG. 2. As shown in FIG. 3, inside one same stator slot, a winding wire d1 and a winding wire d2 are connected in a serial manner to form a coil c1. The winding wire d1 and the winding wire d2 are formed of a copper wire and an aluminum wire respectively.

As shown in FIG. 4a and FIG. 4b, FIG. 4a and FIG. 4b show two specific ways of forming the phase-A winding in FIG. 2, respectively.

Inside different stator slots, coils c1 to c6 are sequentially connected in a serial manner to form the phase-A winding. The coils c1 to c6 are connected in a serial manner, but only the coils c1, c2, and c6 are shown while coils c3, c4, and c5 are not shown. Each coil of the coils c1, c3, and c5 may be formed of a copper wire or two different copper wires connected in a serial manner, while each of the coils c2, c4, and c6 may be formed of an aluminum wire or two different aluminum wires. Specifically, FIG. 4a is a view of each coil being formed by two different wires connected in a serial manner. FIG. 4b shows a phase-A winding formed by 6 coils c1, c2, c3, c4, c5, and c6, and each coil is formed by only two types of wires (that is, the copper wire d1 and the aluminum wire d2). That is to say, each of the coils c1, c3, and c5 is formed by the same copper winding wire d1, and each of the coils c2, c4, and c6 is formed of the same aluminum winding wire d2. It can be understood that the material of the winding wire of each coil of the coils c1 to c6 may be set according to demands, and the present invention is not limited to the forms disclosed in embodiments of the present invention.

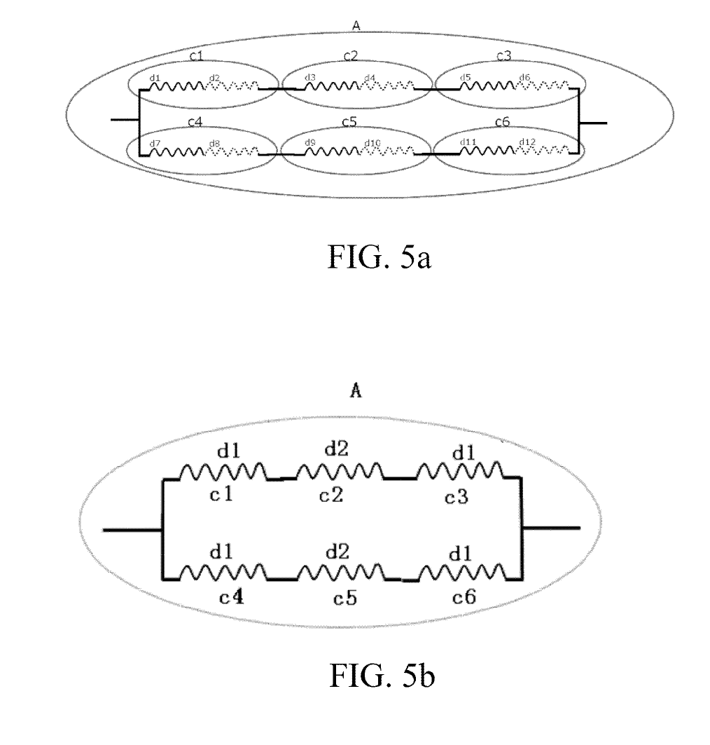

In another example, referring to FIGS. 5a and 5b, inside different stator slots, the coils c1 to c3 are connected in a serial manner, the coils c4 to c6 are connected in a serial manner, and then the coils c1 to c3 connected in series are connected in a parallel manner with the coils c4 to c6 connected in series to form the phase-A winding. That is to say, in the phase-A winding shown in FIG. 5a and FIG. 5b, the coils c1 to c3 are connected in series, the coils c4 to c6 are connected in series, and the coils c1 to c3 and the coils c4 to c6 are connected in parallel. Such a connection manner is referred to as a serial-parallel connection manner of coils in embodiments of the present invention.

Referring to FIG. 5a, each coil of the coils c1, c3, c4, and c6 is formed by using two different copper winding wires (that is, the copper wires have different cross-sections), while each of the coils c2 and c5 is formed by using two different aluminum winding wires (that is, the aluminum wires have different cross-sections). It should be noted that, the solid line in the coil represents a wire, whereas a dotted line represents a different wire. That is to say, the winding wires d1, d2, d5, d6, d7, d8, d11, and d12 are all copper wires, but copper winding wires in a same coil are different. Similarly, the winding wires d3, d4, d9, and d10 are all aluminum wires, and also, aluminum winding wires inside a same coil are different. Alternatively, each coil may further be formed by a same winding wire, referring to FIG. 5b. That is to say, each of the coils c1, c2, c4, and c6 is separately formed by a same copper winding wire d1, while each of the coils c3 and c5 is separately formed of a same aluminum winding wire d2.

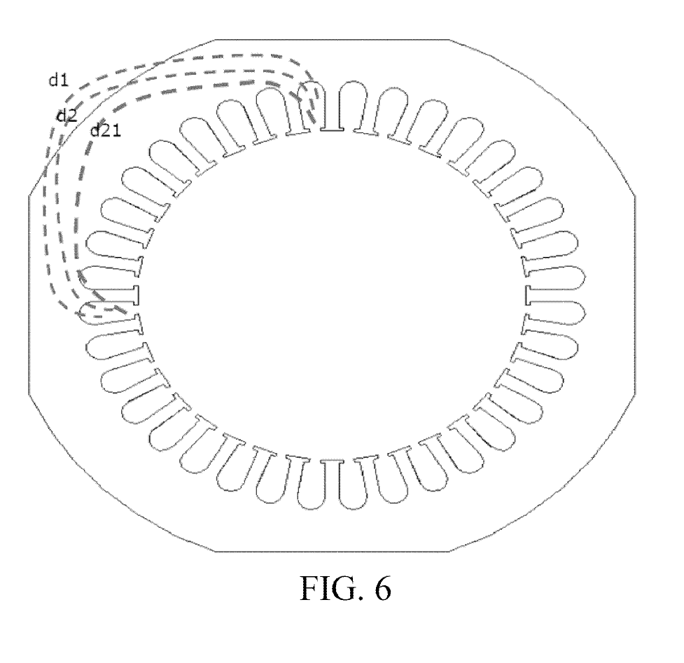

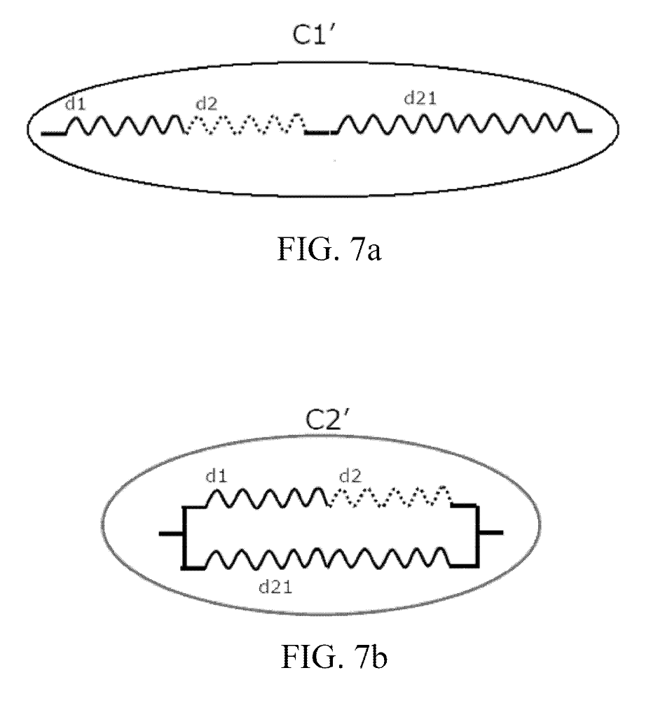

In addition, to illustrate the design concept of the present invention more thoroughly, FIG. 6 to FIG. 7b further show another example of a manner of forming a coil or a phase-A winding according to an embodiment of the present invention. The stator shown in FIG. 6 is basically the same as the stator shown in FIG. 2, and the difference lies in the structure of the coil.

As shown in FIG. 7a, a coil c1′ may be formed by three different winding wires d1, d2, and d21, for example, a copper wire, an aluminum wire, and another copper wire or aluminum wire (specifically, the cross-section of another copper wire or aluminum wire may be the same as or different from that of the winding wire d1 or d2). Alternatively, as shown in FIG. 7b, a coil c2′ may be formed by three different conductive materials or wires connected in a serial-parallel manner, e.g., winding wires d1 (copper wire) and d2 (aluminum wire) are first connected in series, and then the serially-connected winding wires d1 and d2 are connected with a winding wire d21 (copper wire) in parallel.

It is specifically illustrated herein that a single coil used for a motor according to embodiments of the present invention may be formed by wires connected in a serial or serial-parallel manner.

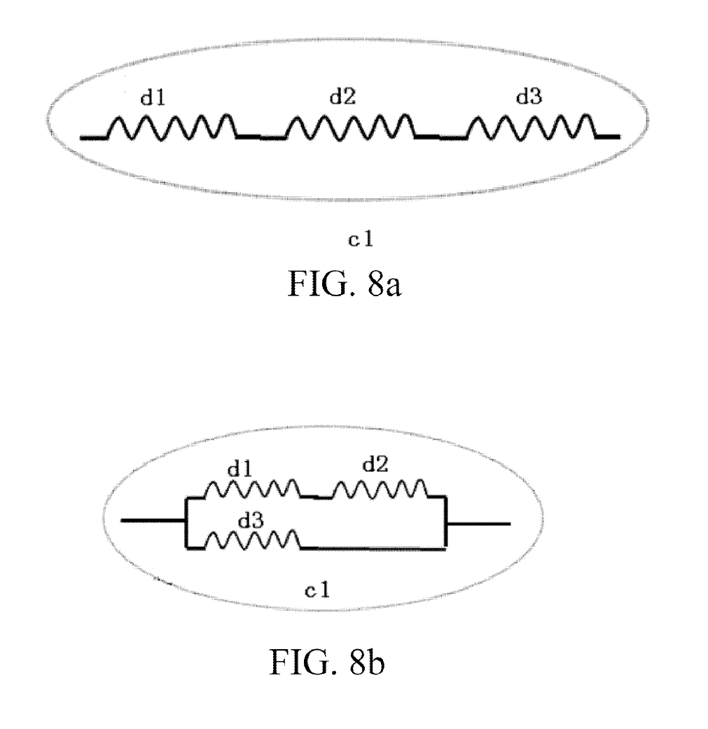

FIG. 8a and FIG. 8b show other two exemplary ways of forming a coil of embodiments of the present invention. FIG. 8a is a view that each coil of an embodiment of the present invention may be formed by three different winding wires d1, d2, and d3. Specifically, each coil may be made of three wires, that is, be formed by different wires d1 to d3 connected in series. FIG. 8b shows that each coil in an embodiment of the present invention may be formed by three different wires d1 to d3 in a serial-parallel manner. The wires d1 to d3 may be wires formed by three different conductive materials. As an example, the wires d1 and d2 may be a copper wire and an aluminum wire, respectively, and the wire d3 may be a copper wire having a cross-section different from that of the wire d1 or may be a silver wire or a wire of another metal material.

In embodiments of the present invention, a core portion of a wire is made of a conductive material, and the core portion is circumferentially coated with an insulating layer or an insulating paint.

As can be seen from the foregoing description, the coil or winding in accordance with embodiments of the present invention may be formed by using at least two different wires or by two different coils (for example, 3, 4, 5 or more types of wires) connected in a serial or serial-parallel manner. That is, FIG. 8a and FIG. 8b only show an example of a coil formed by three wires. However, the present invention is not necessarily limited to such an example.

In another embodiment of the present invention, connecting terminals at two ends of a coil or winding use materials different from materials of the coil or winding. Specifically, the three phases of windings of the motor may be as follows: a phase-A winding is a copper wire, and a phase-B winding and a phase-C winding are aluminum wires. Three phases A, B, and C are usually directly connected to three terminals of a protector respectively at a neutral point of the winding; in this case, a segment of aluminum wire (the length of the aluminum wire is not limited, but may be a very short segment) may be connected between the phase-A winding and a corresponding terminal of the protector, and this segment of aluminum wire is used to connect the phase-A winding and the protector. For the phase-B and phase-C windings, copper wires may be used to connect the phase-B and phase-C windings to the terminals of the protector.

As can be seen from the foregoing description, in embodiments of the present invention, if a part of low resistivity conductors are used, efficiency may be further improved, power density of the motor may also be increased, while the cost is increased slightly (as compared with a situation in which only low resistivity material conductors are used).

In addition, in the present invention, if a part of low cost material conductors are used, the cost of the motor may be reduced, and the volume of the motor is only increased slightly while the original performance of the motor is kept.

Although some embodiments of the general inventive concept have been shown and illustrated, persons of ordinary skill in the art shall understand that changes may be made to these embodiments without departing from the principle and spirit of the general inventive concept, and the scope of the present invention is defined by the claims and their equivalents.

What is claimed is:

1. A stator applied to a single-phase or multi-phase motor, comprising:
a stator iron core;
a plurality of stator teeth extending inwards along a radial direction of the stator;
stator slots distributed between the plurality of stator teeth; and
a single-phase winding or multi-phase windings wound around a stator tooth to generate a rotating magnetic field, wherein at least one phase of winding among the windings or a coil forming the at least one phase of winding is made of different wires, and the different wires are connected in a serial or serial-parallel manner to form the coil or the at least one phase of winding.

2. The stator according to claim 1, wherein
inside one same stator slot, at least two types of wires are connected in a serial manner to form the coil or the at least one phase of winding.

3. The stator according to claim 2, wherein
the at least two types of wires are a copper wire and an aluminum wire respectively, and the copper wire and the aluminum wire are connected in series to form the coil or the at least one phase of winding.

4. The stator according to claim 1, wherein,
inside different stator slots, at least two types of wires are connected in a serial manner to form the coil or the at least one phase of winding.

5. The stator according to claim 1, wherein
inside one same stator slot, the different wires are connected in a serial-parallel manner to form the coil or the at least one phase of winding.

6. The stator according to claim 1, wherein
inside different stator slots, the different wires are connected in a serial-parallel manner to form the coil or the at least one phase of winding.

7. The stator according to claim 1, wherein
the different wires are wires made of a same material and having different cross-sectional areas, or wires made of different materials and having different electrical conductivities.

8. The stator according to claim 7, wherein,
a core portion of each of the different wires is made of a metal material and is circumferentially configured with an insulating layer or an insulating paint.

9. The stator according to claim 8, wherein,
the metal material is any one of copper, aluminum, silver, gold, and an alloy.

10. The stator according to claim 2, wherein
the different wires are wires made of a same material and having different cross-sectional areas, or wires made of different materials and having different electrical conductivities.

11. The stator according to claim 4, wherein
the different wires are wires made of a same material and having different cross-sectional areas, or wires made of different materials and having different electrical conductivities.

12. The stator according to claim 5, wherein
the different wires are wires made of a same material and having different cross-sectional areas, or wires made of different materials and having different electrical conductivities.

13. The stator according to claim 6, wherein the different wires are wires made of a same material and having different cross-sectional areas, or wires made of different materials and having different electrical conductivities.

14. A motor, comprising a rotor and a stator, the rotor being rotatably disposed in the stator and separated from the stator by a distance, wherein
the stator comprises:
a stator iron core;
a plurality of stator teeth extending inwards along a radial direction of the stator;
stator slots distributed between the plurality of stator teeth; and
a single-phase winding or multi-phase windings wound around a stator tooth to generate a rotating magnetic field, wherein at least one phase of winding among the windings or a coil forming the at least one phase of winding is made of different wires, and the different wires are connected in a serial or serial-parallel manner to form the coil or the at least one phase of winding.

15. The motor according to claim 14, wherein
inside one same stator slot, at least two types of wires are connected in a serial manner to form the coil or the at least one phase of winding, or the at least two types of wires are connected in a serial-parallel manner to form the coil or the at least one phase of winding; or,
inside different stator slots, the at least two types of wires are connected in a serial manner to form the coil or the at least one phase of winding, or the at least two types of wires are connected in a serial-parallel manner to form the coil or the at least one phase of winding.

16. The motor according to claim 15, wherein,
the motor is a constant-frequency motor or a variable-frequency motor.

17. The motor according to claim 16, wherein,
the motor is a three-phase induction motor or a three-phase permanent-magnet motor.

18. The motor according to claim 17, wherein,
a working voltage of the motor or a driver of the motor is 208 V to 575 V.

19. A compressor, comprising a compression mechanism, and a motor comprising a rotor and a stator, the rotor being rotatably disposed in the stator and separated from the stator by a distance, wherein
the stator comprises:
a stator iron core;
a plurality of stator teeth extending inwards along a radial direction of the stator;
stator slots distributed between the plurality of stator teeth; and a single-phase winding or multi-phase windings wound around a stator tooth to generate a rotating magnetic field, wherein at least one phase of winding among the windings or a coil forming the at least one phase of winding is made of different wires, and the different wires are connected in a serial or serial-parallel manner to form the coil or the at least one phase of winding.

20. The compressor of claim 19, wherein in the stator, inside one same stator slot, at least two types of wires are connected in a serial manner to form the coil or the at least one phase of winding, or the at least two types of wires are connected in a serial-parallel manner to form the coil or the at least one phase of winding; or,
in the stator, inside different stator slots, the at least two types of wires are connected in a serial manner to form the coil or the at least one phase of winding, or the at least two types of wires are connected in a serial-parallel manner to form the coil or the at least one phase of winding.
